(19) United States
(12) Patent Application Publication
(10) Pub. No.: US 2007/0284387 A1
(43) Pub. Date: Dec. 13, 2007

(54) Dispenser system

(76) Inventors: Mark R. Ellswood, Alpharetta, GA (US); Sean P. Gorman, Cumming, GA (US); Alan G. Shuman, Canton, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/450,545

(22) Filed: Jun. 9, 2006

(51) Int. Cl. G07F 11/00

(52) U.S. Cl. 221/92

(57) ABSTRACT

A multi-product dispenser is disclosed. The dispenser unit has a body or housing that includes a number of chambers adapted to receive and accommodate a number of individual product containers. Each of the chambers in the housing has an opening that is distinctly configured relative to another opening adapted to dispense each kind of product that is to be dispensed from the housing. The container may have a movable panel or false bottom and an opening situated opposite the movable panel, and the housing may have a spring-like, tension-based member adapted to contact or engage with the movable panel that advances the movable panel toward the opening of both the container and housing. The invention also discloses a method for informing a user about a proper sequence or protocol for using protective products.

### FIELD OF INVENTION

The present invention relates generally to an assembly or device for dispensing a number of protective articles. In particular, the invention provides access to protective articles, such as gowns, masks, or gloves, in a systematic arrangement to more easily maintain hygienic or antimicrobial properties of the protective articles.

### BACKGROUND

In certain laboratory, industrial, or health care settings a worker often may need to don a variety of personal protective equipment or articles. These articles are accessed in dispensing systems that contain a quantity of gloves, gowns, or facemasks, that are stored typically in corrugated boxes with a perforated opening. When the perforated cover of the opening is removed, a user can reach through to withdraw the protective articles from the container. Problems exist with this kind of system.

First, workers often complain that presently available conventional storage or dispensing units are too small and hence not able to contain sufficient amounts of personal protective articles. Second, the U.S. Centers for Disease Control (CDC), in Atlanta, Ga., United States, has provided guidelines for the proper protocol order for donning protective articles that will either preventing contamination or transmission of infectious agents. Unfortunately, many people either follow the order specified in the guidelines correctly, do not follow them completely, or not at all, which can increase the likelihood of transmission of hospital-acquired infections (HAI) for both the healthcare worker and/or patient. A graphic interface that instructs a user on the correct sequence for donning personal protective equipment would provide training benefits for either a novice or a reminder to an experienced worker, as well as reduce likelihood of contamination and transmission of infectious agents, and contribute to overall better hygiene. The failure of some to wear protective products has caused significant issues for health and hygiene.

An all-in-one dispenser assembly or system can be a welcome and useful device, which is configured to hold and dispense a plurality of protective articles and which maintains the articles, such as gloves, continuously next to a dispensing opening; thus, eliminating to the need for the user to reach into deep containers. An advantage of such a dispenser assembly would be the relatively large volume of the dispenser housing, which allows the user to access all products when needed without having to constantly re-supply the dispenser. The assembly desirably permits a plurality of protective articles to be easily dispensed one at a time. It would be portable. In the healthcare setting, the worker can provide care to a patient for safe working conditions. Such a dispenser also desirably permits gloves to be oriented such that a wrist area or cuff of at least some of the gloves is presented at the opening for a user to grasp for withdrawal. In addition, the opening to the dispenser is desirably configured and positioned such that little surface area of the glove adjacent the opening is exposed. The gloves are desirably positioned in such a dispenser so that only one glove at a time is positioned adjacent the opening. Such a dispenser also is desirably configured to operate and dispense gloves in either a horizontal or vertical position. The dispenser assembly desirably is portable and easily mounted, if desired, on a surface.

### SUMMARY OF THE INVENTION

The present invention pertains in part to an all-in-one multi-product dispenser system or assembly. The assembly can take the form of a small, easily organized mobile cart or wall-mountable fixed stand. In another aspect, the invention relates to a method for informing a user about a proper sequence for applying, donning, or using protective product articles so as to maintain sanitary or hygienic conditions, such as in healthcare or laboratory settings, to reduce chances of being infected with HAls.

The present invention increases the overall storage capacity of personal protective products, in a dispenser unit. The availability when needed of the right size product article, such as a glove or face mask, can greatly enhance the ability of the user to do his work. In the healthcare area, for example, a healthcare worker is more likely to wear the protective products than not if the properly sized article (e.g., garment or glove) is readily at hand, which increases the overall level of protection against contamination or infection for both the healthcare worker and the patient. The present invention also pertains a method of instruction for the proper sequence or protocol for using protective products.

Additional features and advantages of the present dispenser system invention, packaging, and methods of use and instruction will be disclosed in the following detailed description. It is understood that both the foregoing summary and the following description are merely representative of the invention.

### BRIEF DESCRIPTION OF DRAWINGS

FIG. 1 is an illustration of an embodiment of the present invention, shown as a mobile cart, showing the presence of a storage space. The dispensing unit has a number of separate chambers, each adapted to hold a particular kind of product and having an opening configured to dispensing the particular product that permits a user top easily access to the product.

FIG. 2 is another view in three-quarter perspective of the embodiment shown in FIG. 1.

FIG. 3 is a three-quarter perspective view of an alternative embodiment which may be mounted on or against a wall.

FIG. 4 is a general cross-sectional illustration along a vertical bisection of the dispenser unit of FIG. 1, showing an interior portion of the dispenser housing with a number of individual product container positioned respectively within their corresponding chambers as when the unit is fully stocked.

FIG. 5A is a partial cut-away view in three-quarter perspective of a section of the dispenser unit shown in FIG. 1, 2 or 3. The cut bisects an opening of the chamber, a first and a second carton box containing certain packaged products. The chamber opening is arranged to align with the first carton box. The first carton box, according to the illustration, rests against a back support surface which positions the carton box at a slightly upward tilted angle with the access opening to the box facing toward the left of the Figure. A tension-based, spring-like member is affix on one end to the back support surface and extends into the volume of the first carton box. The second carton box is placed behind the tilted, first carton box, where it can be stored until needed after the contents of the first box becomes depleted.

FIG. 5B is a more detailed view in three-quarter perspective of the spring-like member, which according to an embodiment is depicted as a metal strip or projection attached to a surface of a back support plate. Also shown is the upper part of a second carton box, which is partially obscured behind the support plate.

FIGS. 6A-6C are various views from different perspectives, front and rear, of the interior of the dispenser unit showing the relative positions and arrangement of the individual product container boxes and chambers respectively.

### DETAILED DESCRIPTION OF THE INVENTION

The particular design and arrangement, it is believed, can provide better protection to a user, in the situation for example of a healthcare worker, such as a nurse or physician, and enhance the overall health or safety to a patient he or she contacts from contamination or infection.

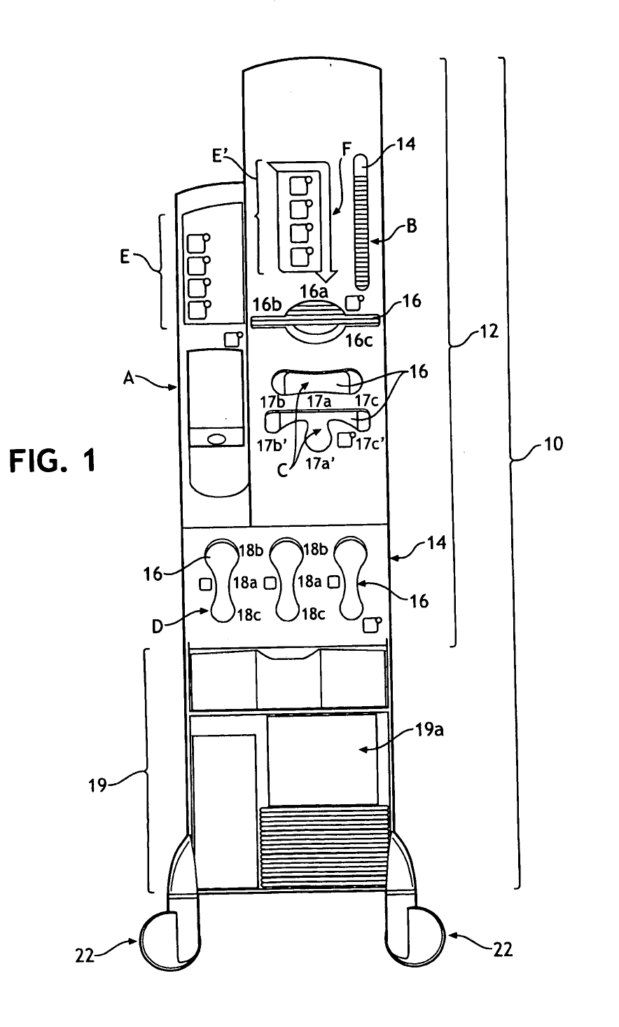

The present invention involves a multi-product dispenser 10, such as illustrated generally in FIG. 1, having a housing or structure 12 with a number of chambers 14 adapted to receive and accommodate a number, desirably a plurality, of individual product containers 1. Each of the chambers 14 in the housing 12 has an aperture or opening 16 that is distinctly configured relative to another opening, and is adapted to dispense each respective kind of product from the housing. The openings are situated along one side of the housing for access to the interior of the housing from the side. The chambers are adapted to hold a combination of at least two of the following types of products in respective containers: such as, (A) a hand- or body-cleaning or sanitizing medium, solution, or lotion 2, (B) a protective article that covers a major portion of a user's body 4, (C) a face mask 6, or (D) a glove 8. FIGS. 1-4, illustrate a general full-featured embodiment of the invention. The needs or desires of a user may dictate the final, actual configurations of other embodiments of the dispenser housing. For example, if a user does not wish or need either a face mask or a cleaning/sanitizing medium, but would like to have more chambers available for protective coverings or garments, the realized dispenser housing can be adapted such that the face mask and cleaning medium chambers are not included and are substituted instead with a second or third garment chamber. Thus, it is desirable that the embodiments of the dispenser housing be modular and adaptable to include a combination of any two or more type of products.

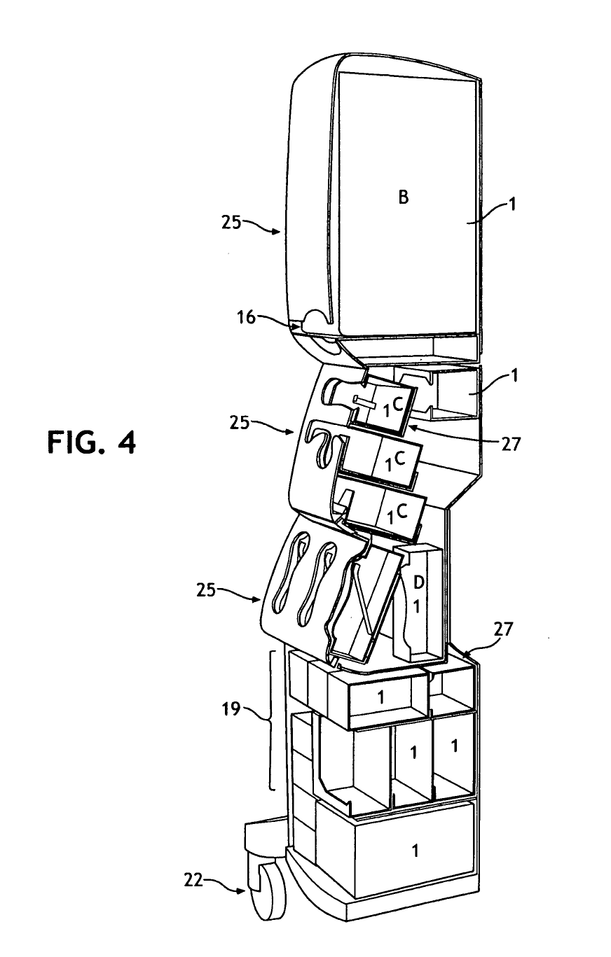

As shown in FIG. 4, the respective chambers (A, B, C, D) for products are arranged or configured within the dispenser housing unit in preferably a logical sequence that helps facilitate a user follow a set protocol for using the products, such as according to the CDC-suggested guidelines for donning. The hand-cleaning or sanitizing medium or solution can be either a liquid or solid soap or a sanitizer or antimicrobial or antiviral solution. The hand-cleaner may be either effective or not effective to clean or sanitize in either the presence or absence of liquid water. Each container can hold a plurality of protective articles, such as medical examination gloves, or article of clothing, such as a cover drape or sheet, gown or a head wear (e.g., a cap). The personal protective articles or equipment are typically bulk-packaged products and not sterile.

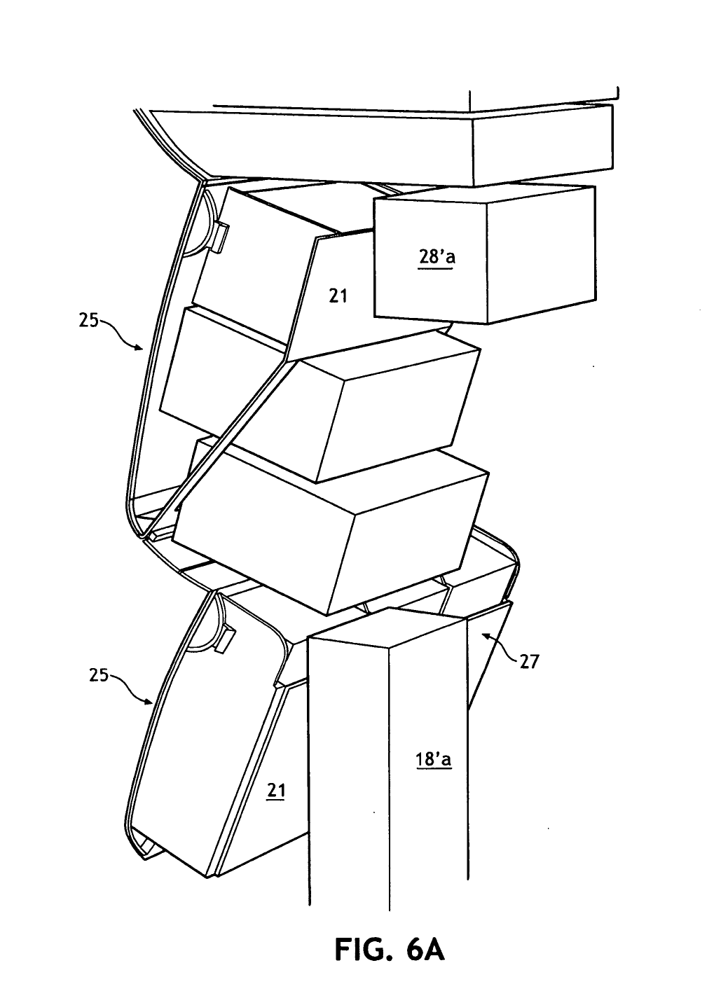

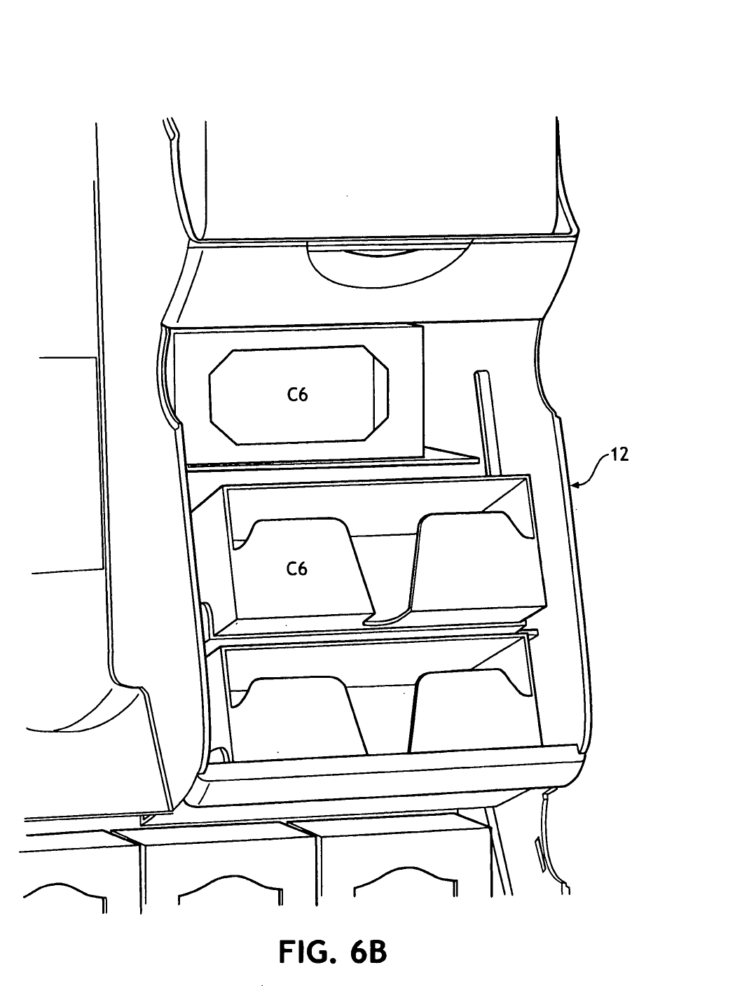

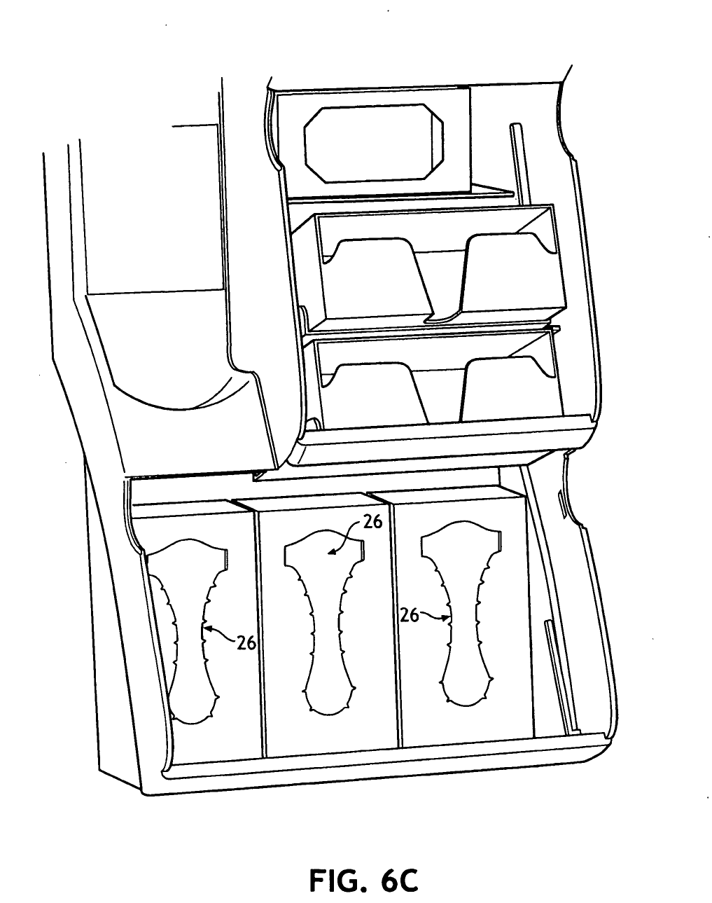

FIGS. 6A-6C illustrate various arrangements of individual product containers within the dispenser unit. FIG. 6A is a schematic view from a rear, three-quarter perspective of the dispenser unit, with the body walls of he dispenser removed. The illustration depicts positions of how the various product containers sit relative to each other within the housing behind a front panel or face plate 25. With the front panel removed from the dispenser unit, FIGS. 6B and 6C show a view from the front of the upper face mask chamber and the lower glove chamber, respectively, each with a number of individual product containers. Each container has an access opening adapted to work respectively with the shape of their corresponding dispenser openings in the front face place. To resupply product containers located behind the front face panel one can merely lift or remove the front panel 25 and replace the panel when done. Some of the support plates 27 that position the product cartons can be pulled forward or to a side on a hinge to allow easy access to areas behind the immediate dispensing area near the housing access ports of each chamber. For sake of ease and convenience, the front panel can be conceptualized as a specially shaped “door”.

Each of the respective chambers 14 has an opening 16 that has a middle section 16a and two terminal sections 16b, 16c. Generally, the opening for dispensing the protective articles of clothing may be in the form of a slot A4, in which the middle section has a relatively wider dimension than either terminal section. The slot desirably has a substantially horizontal orientation. In contrast, the opening for the chamber C6 adapted to hold a face mask can have either: a) a middle section 17a that has a narrower dimension relative to either of the terminal sections 17b, 17c, or b) a middle section 17a′ that has a wider dimension relative to either of the terminal sections 17b′, 17c′. Alternatively, the chamber adapted to hold a face mask according to the configuration of b) has a T-like form, oriented substantially either vertically, horizontally, upside-down, or right-side up.

The opening for a chamber adapted to hold a glove has a middle section and two terminal sections, in which the middle section 18a has a narrower dimension relative to either of the terminal sections 18b, 18c, wherein the terminal section are either of substantially the same shape, size, or dimension as each other, or one of the terminal sections can be larger and has a different shape relative to the other. The glove chamber opening in certain desired embodiments can have a shape that has a narrowing or tapering along part of the opening, to create a form that is reminiscent of an hourglass-like, tear-drop-like, paddle-like form, or dog-bone-like shape. The middle and two terminal portions of the openings to ether the face mask chamber according to the embodiment described in a), above, or the glove chamber has general width or size dimensions that relate to each other according to a ratio in a within a range (t:m:t) of about 1.01:1:1.01 to 20:1:20, inclusive of all ratio combinations in between, or alternatively, a ratio of about 1.1 or 1.2:1:1.1 or 1.2 to about 15:1:15, inclusive. Some examples of particular ratios may include: 1.25:1:1.25; 1.5:1:1.5; 3:1:2; 3:1:3; 3:2:3; 3:2:1; 4:1:2; 5:1:3; 5:2:3; 5:3:1; 7:2:3; or 9:3:5.

The container opening and the dispenser housing access port 16 correspond with each other and have a similar shape and dimensions. The container opening and the housing access port each can have a middle section and two terminal sections, in which the middle section has a narrower dimension relative to either of the terminal sections, wherein the terminal section are either of substantially the same shape, size, or dimensions as each other, or one of the terminal sections is larger and has a different shape relative to the other terminal section. So as to be compatible with the dispenser openings in the housing, the container openings and the housing access port each has either an hourglass-like shape, a paddle-like shape, or a dog-bone-like shape, such as shown when comparing housing access ports of FIGS. 1-5A with the product box openings 26 in FIG. 6C. The container is adapted for holding face masks or gloves.

For the chambers that hold gloves, the opening preferably is oriented substantially vertically with the two terminal portions above and below the middle section. When the terminal portions are dissimilar in size of shape, according to certain designs when the cuff region of each glove is positioned upward, preferably the terminal portion that is larger is situated above the smaller portion, which permits for easier access to the gloves.

As shown the dispenser has a plurality of glove dispensing chambers, which in certain desirable embodiments number three—one each for large, medium or small sized gloves to suit any sized hand. Other configurations can also be employed. Depending on the requirements or preferences of users and what sizes they may wish to fill each chamber, all three dispensing chambers may contain a different size or the same sized glove, or a combination of the three sizes.

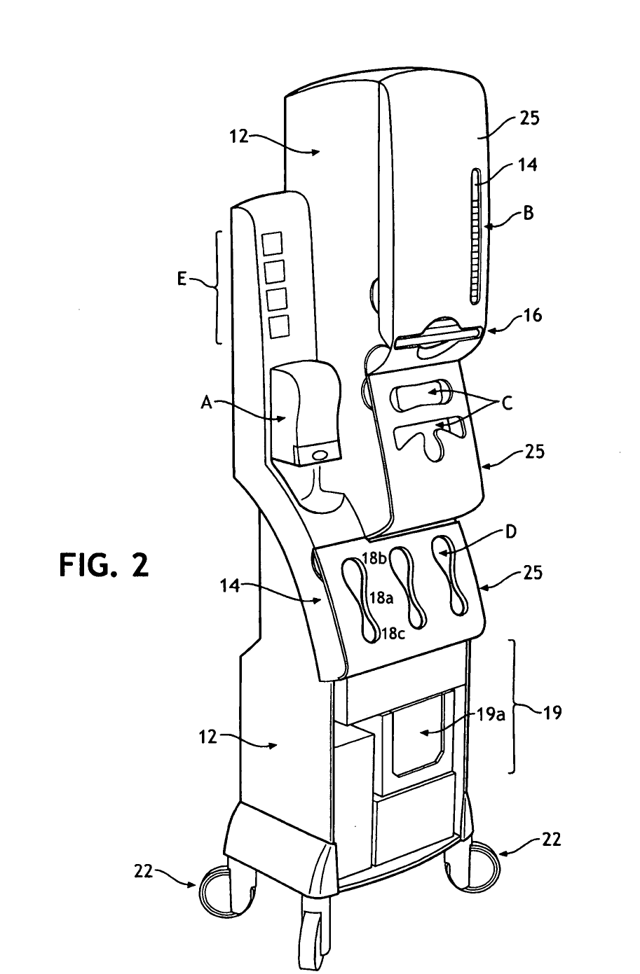

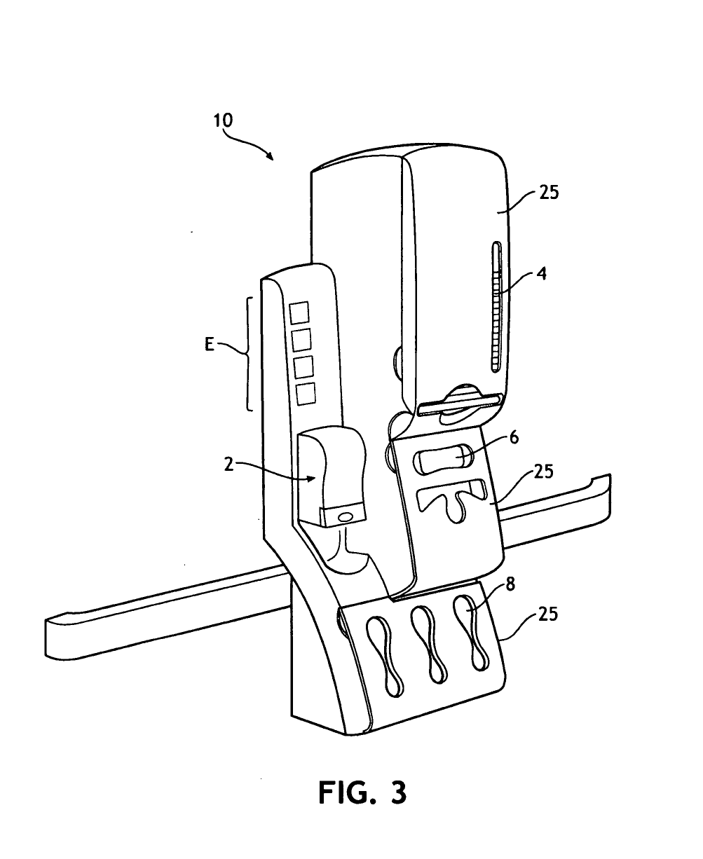

The housing may constitute part of a cart, as in FIGS. 1 and 2, either with or without wheels or coasters (e.g., casters) 22 to enable the cart to be movable. The mobile cart is small so as to permit it to be easily brought to the work area, such as positioned at the side of a patient, wherever the patient is located, including an emergency room, hospital ward, clinical examination room, or any other work area. The cart can facilitate the operator grabbing the cart and bringing it to the patient's side while the operator's hands are uncontaminated. Additionally, in certain embodiments, the cart can be height adjustable, using for instance, a height pole or brackets and sockets. This enables the user to configure the dispenser conveniently for best access. Alternatively, the housing can be mountable on or against a wall, such as shown in FIG. 3. In this latter embodiment, it may be desirable to place the unit near a sink and faucet or other source of water for washing. The dispenser unit housing and constituent parts can be made from a variety of light weight materials, for example, stainless steel, aluminum, elastomers, thermoplastics or polymers, or combinations thereof.

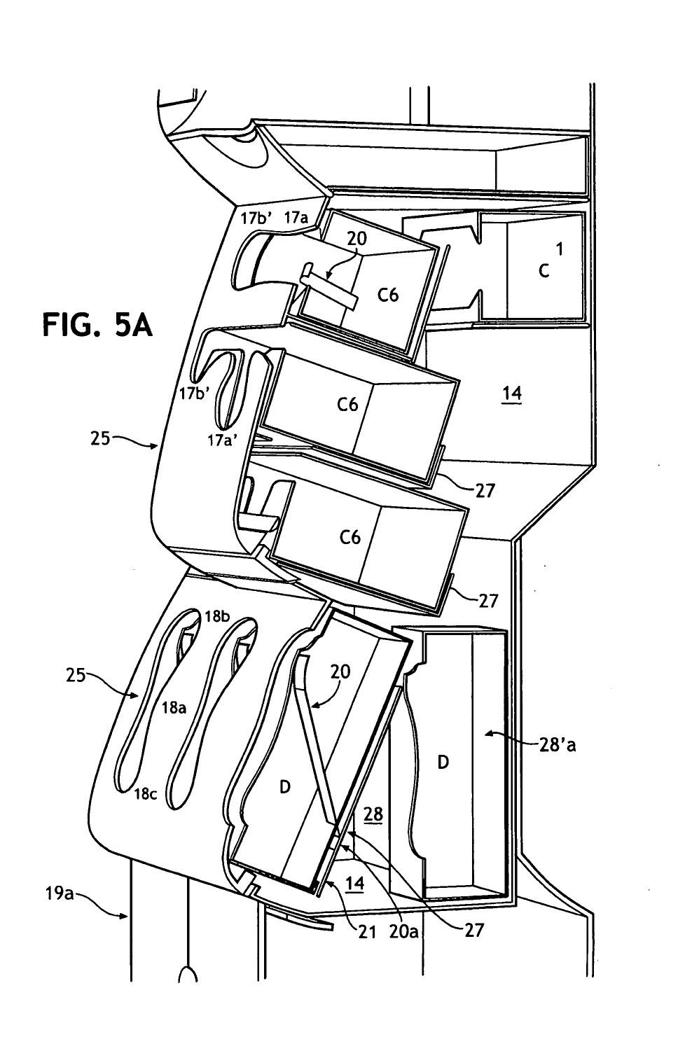

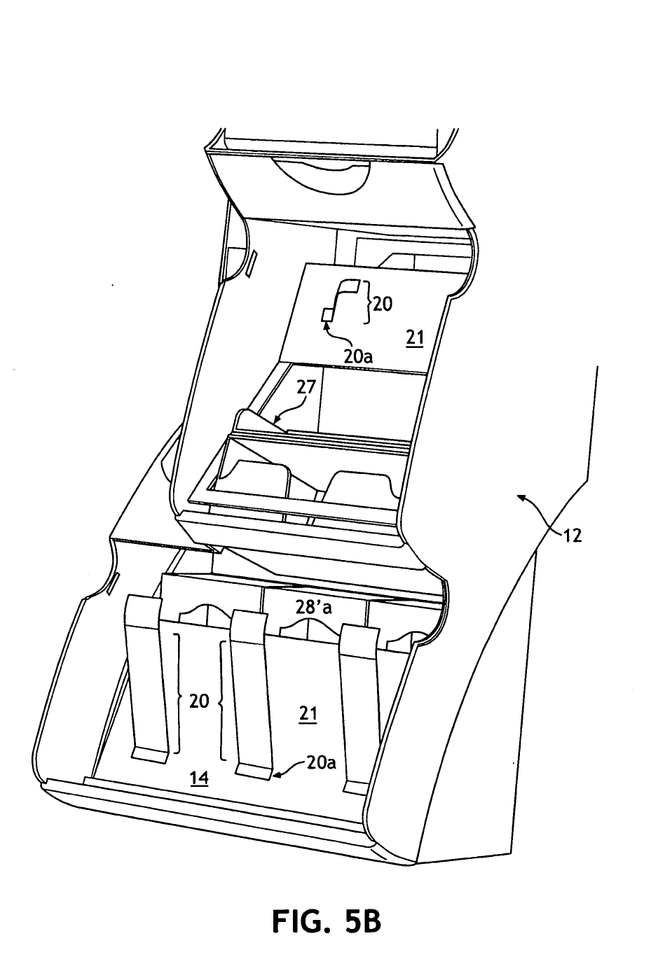

The overall dispenser housing may include an enclosed storage space 28 for keeping surplus containers 28′a of the products until they are ready to be use, such as shown in FIG. 1 or 5A and 5B. In FIG. 1, the dispenser has a number of additional storage space 19, which such as an enclosed cabinet with a door 19a or doors, situated underneath the portion of the housing used for actively dispensing products. The cabinet provides a self-contained place conveniently near at hand, to put additional cartons of product until they are needed. Also, the cabinet can be configured to have either open selves or sliding drawers or trays for other equipment. Alternatively, the storage space can have either fixed or adjustable open selves in the either the lower cabinet or upper dispensing housing. In another variation or embodiment, additional storage space can be located within the actively dispensing portion of the housing. If the housing is designed with sufficient depth or interior volume, one can accommodate at least two individual product containers adjacent to each other. That is, while a first container or carton of product can be opened and placed immediate to the dispenser opening for the products within to be used, a second or third full container can be positioned at the ready near or beneath the first carton, such as shown in FIGS. 5A and 5B. Once product is used up or emptied from the first container, a worker can easily remove the empty container and replace it with a new full container. The enclosed nature of the cabinet with a door or two can protect the stored products and their containers from external contamination, and also promote an aesthetically clean and neat appearance. The storage shelving or cabinet may be situated in an area either underneath or behind the main part of the dispenser housing having active open containers. These changes and adaptations address a common complaint of workers, which is a need to got to the supply room to restock conventional dispensers. With in the present design, one can store a greater number of protective products than conventional dispensers do.

Products such as face masks or examination-style gloves used in medical, clinical, or laboratory settings are typically bulk-packed or loosely stacked in a paper-folding or cardboard housing (i.e., carton box or package). For example, gloves may be positioned to dispense in a vertical position. When the gloves are presented vertically, one or more portions of gloves often protrude through the opening when the dispenser is nearly or completely filled with a plurality of gloves. When the dispenser is completely or nearly full, it can be difficult for a user to grasp one glove without causing inadvertent dispensing of additional gloves, resulting in waste. Once the first 10 to 20 percent of the gloves are dispensed, problems continue to exist. At this point, a space between the opening and the plurality of gloves is created. This space requires a user to place a portion of his/her hand into the opening to grasp a glove. As this space increases when 30 percent of more of the gloves are dispensed from the dispenser, the gloves have a tendency to collapse from their dispensing position and to clump together at the bottom of the dispenser. This results in a user having to place his/her hand deep into the dispenser to obtain a single glove. Similar problems exist in horizontal dispensing.

Conventionally, in a dispenser that dispenses gloves from a horizontal position (i.e., with the main opening or access aperture oriented towards an upper or top surface of the carton and largely parallel to a surface against which the box rests, such that the product within the box is largely in a horizontal position), the same problems occur when the dispenser is nearly or completely full of gloves. Again, once the first 10-20 percent of gloves are dispensed, the user is required to place his/her hand into the opening of the dispenser to retrieve a glove. While clumping may not occur, the continued admittance of user hands into a dispenser opening may result in contamination of one or more gloves, or the entire internal compartment of the dispenser and most or all of the plurality of gloves. In addition, in either horizontal or vertical dispensing, the space which occurs between the dispensing opening and the gloves permits contaminants to enter the dispenser.

As the product content in the carton is used up, the stack of products recedes lower into the volume of the carton due to gravity. The shortening stack height requires a user to have to reach into the volume of the carton, and makes access the product progressively more difficult to reach the remaining product items, and increases the likelihood that the remaining product to become contaminated with bacteria or dirt. This awkward situation is compounded with larger package sizes and the desire to place an every increasing product count per box, where a deeper or taller box is needed to contain the initial product stack (e.g., depth of the carton box may be a minor issue for a 10-20 or 30 count stack, but can be problematic for a 100-300 or 400 count stack).

Occasionally, a carton box is placed on it side, with the main opening is oriented perpendicular to the resting surface, in an attempt to make it easier for the user to reach the product. In this kind of orientation, sometimes the face mask or glove tends to fall forward toward the opening as product is consumed, but often the product will tend to slump in the back of the carton and would still require the user to reach deep into the box when the contents are nearly depleted, and avoid a user potentially contaminating the remaining product items.

To overcome this problem, according to another embodiment of the invention, the face mask or glove chambers have, situated in a portion of each respective chamber opposing the chamber opening, a tension-operated member that advances a substrate forward toward the chamber opening and which maintains a product article at or in near proximity to the chamber opening. This tension-operated member can take the form of a spring or a resilient, compressible metal projection or strip 20, such as illustrated in FIGS. 5A and 5B. The spring-like device 20 pushes the contents of the package towards the opening of the box, as the counter pressure of the product stack lessens with use. This allows the next product item to be readily accessible without the need for the user to reach deep into the box. As shown in FIGS. 5A and 5B, a resilient plastic or metal finger-like projection or strip 20 is securely fixed on one end 20a to a solid surface or backing 21 and the rest of the spring-like member is configured or bent at an angle away from the affixed backing, and allows the projection to perform in a “spring-like” fashion.

The spring-like or assisted dispensing member 20 can be configured as a single dispensing system or within a modular system that serves multiple purposes. Having the product constantly advanced toward the opening permits the next available product to be near the box opening for easy access, making it more convenient for users in fast-paced healthcare settings to quickly grab product without contaminating the remaining items. The spring-like member can be configured or constructed in different ways and/or with a plurality of projections under tension. Where multiple members are used, for example, the spring constants could be either the same or different, depending on the amount of counter force and desired outcome. For instance, having similar spring force constants may be more desirable when one wishes to push the product from one end or side of the carton so as to present a preferred point of touch to the user during dispensing.

According an embodiment, the spring-like member works in conjunction with a product container package. The carton box used in conjunction with the spring-assisted dispenser can have at least two openings: a first opening in the box top for product dispensing, and a second in the box bottom to allow access for the spring-like member to push against the product. These openings can be exposed by removing perforations in the box material from the openings. The first opening is adapted to align with the opening of the chamber in the dispenser unit, and preferably also has a shape that substantially matches the configuration of the chamber opening. That is, for example, with a chamber opening having an hourglass-like form, the carton box opening through which product is dispensed has the same shape. The spring-like member applies a constant pressure against the bottom of the stack of product, thereby pushing the stack towards the opening for dispensing, for instance, through an opening in the bottom of the carton. Alternatively, in certain iterations, the carton box can have either a free-floating panel or movable false bottom situated between the product stack, the bottom of the box, and the spring-like member. The panel, which is allowed to move back and forth within the volume defined by the walls of the carton, functions as a platen against which the spring-like member can press and push the product forward. Some products may benefit from using a load spreader to distribute the spring contact point across a larger surface area. The load spreader can be a floating panel, which is constructed from a suitably rigid or stiff material (e.g., cardstock, plastic, metal corrugated materials) to support the product on one side and the pressure points from the spring-like member on the other without warping or buckling. For example, face masks or elastomeric gloves products may use a 24 pt. solid bleached sulfate (SBS) paper board with sufficient stiffness as a panel backing.

Hence, according to an iteration, the dispenser has a housing adapted to accommodate at least one or more containers. The container box having a movable panel and an opening situated opposite or across from the movable panel. The housing has, situated in a portion of the housing opposite an access port, a tension-based member adapted to contact or engage with the movable panel, such that as contents of the container are removed from the container, the tension-based member advances the movable panel toward the container opening and housing access port. The movable panel in the container constitutes a portion of a back-facing or bottom part of a box, and the container opening is a portion of a front-facing or top part of a box.

The present invention also contemplates a graphic-user interface (E or E′). The graphic display can be a valuable aid for teaching others, such as trainees, technicians, etc. how to properly apply personal protective equipment. In some embodiments, this graphical interface is part of the dispenser housing and has an informational schematic or display that instructs a user of the protective products in a proper sequence (i.e., CDC-suggested protocol) for applying, donning, or using the protective articles. The informational display provides instruction on a method for properly donning protective articles, such as products that have antimicrobial or antiviral media coatings. The informational display can include a number of schematic figures, icons, words, other indicia or symbols, or combinations thereof to represent or illustrate each step of the sequence. The informational display provides instruction on a method for properly donning protective products or anti-infectious articles. In the examples shown in FIG. 1 or 2, the graphical interface is has a series of icons and words that instructs the user on a proper sequence of donning antimicrobial protective articles, as indicated with an arrow F. The user is told that step one involves washing or cleaning one's hands with the sanitizer (first hand icon), step two is dressing in a gown or other covering (shirt icon), step three is putting on a face mask (face or head icon), and step four is donning gloves (second hand icon).

A proper sequence can be expressed in a method that comprises: providing a dispenser device having a housing body with an informational schematic or display that instructs a user on the product articles; either providing to or having the user follow instruction by means of a number of schematic figures, icons, or wording to represent each step of the sequence. The method can further include the steps of: first either cleaning or sanitizing the user's hands or other body part using a cleaning or sanitizing medium, second donning a protective covering over a major portion of the user's body; optionally donning either a facial or head cover; and third donning a glove. Alternatively, the method may merely include donning a protective covering and a glove. The specific method that is described or depicted on the graphical interface can be adapted to comply with either CDC-suggested protocols or a variety of other particular or predetermined user, laboratory, or hospital-designated protocols, depending on the user's needs or industry standards.

The present invention has been described in general and in detail by way of examples in connection with certain preferred embodiments, it is to be understood that the subject matter encompassed by way of the present invention is not to be limited to those specific embodiments. On the contrary, it will be appreciated that some elements and/or articles may be used with other elements or articles. Persons of skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein.

We claim:

1. A multi-product dispenser comprising: a housing having a number of chambers adapted to receive and accommodate a number of individual product containers; each of said chambers in said housing has an opening that is distinctly configured relative to another opening adapted to dispense each kind of product of said housing.

2. The multi-product dispenser according to claim 1, wherein said housing has chambers adapted to hold a combination of at least two of the following types of products in respective containers for:
a cleaning or sanitizing medium, solution, or lotion, a protective article that covers a major portion of a user's body, a face mask, and a glove.

3. The multi-product dispenser according to claim 1, wherein said cleaning or sanitizing medium or solution is either soap or an antimicrobial solution, that may be either effective or not effective to clean or sanitize in either the presence or absence of liquid water.

4. The multi-product dispenser according to claim 1, wherein said protective article is an article of clothing, a gown, or a head wear.

5. The multi-product dispenser according to claim 1, wherein said dispenser housing is has a modular configuration that can be modified to contain a combination of any two or more types of said products.

6. The multi-product dispenser according to claim 1, wherein said opening for said chamber adapted to hold a protective article of clothing is a slot with a middle section and two terminal sections, said middle section having a relatively wider dimension than either terminal sections of said slot.

7. The multi-product dispenser according to claim 6, wherein said slot has a substantially horizontal orientation.

8. The multi-product dispenser according to claim 1, wherein said opening for said chamber adapted to hold a face mask has a middle section and two terminal sections, in which either a) said middle section has a narrower dimension relative to either of said terminal sections, or b) said middle section has a wider dimension relative to either of said terminal sections.

9. The multi-product dispenser according to claim 1, wherein said opening for said chamber adapted to hold a face mask according to b) has a T-like form, oriented substantially either vertically, horizontally, upside-down, or right-side up.

10. The multi-product dispenser according to claim 1, wherein said opening for said chamber adapted to hold a glove has a middle section and two terminal sections, in which said middle section has a narrower dimension relative to either of said terminal sections, wherein said terminal section are either of substantially the same shape, size, or dimensions as each other, or one of said terminal sections is larger and has a different shape relative to the other.

11. The multi-product dispenser according to claim 1, wherein said glove chamber opening has either an hourglass-like form, a tear-drop-like form, a paddle-like form, or a dog-bone-like form.

12. The multi-product dispenser according to claim 1, wherein said middle and said two terminal portions of said opening to said face mask chamber and said glove chamber has dimensions that relate to each other according to a ratio (t:m:t) in a within a range of about 1.01:1:1.01 to 20:1:20, inclusive.

13. The multi-product dispenser according to claim 1, wherein said housing includes an enclosed storage space for keeping surplus containers of said products until ready for use.

14. The multi-product dispenser according to claim 1, wherein said housing constitutes part of a mobile cart.

15. The multi-product dispenser according to claim 1, wherein said housing is mountable on or against a wall.

16. The multi-product dispenser according to claim 1, wherein said face mask or glove chambers have, situated in a portion of each respective chamber opposing said chamber opening, a tension-operated member that advances a substrate forward toward said chamber opening and which maintains a product article at or in near proximity to said chamber opening.

17. The multi-product dispenser according to claim 1, wherein said housing has an informational schematic or display that instructs a user of said products about a proper sequence for applying, donning, or using said products.

18. The multi-product dispenser according to claim 17, wherein said informational display provides instruction on a method for properly donning protective product articles.

19. The multi-product dispenser according to claim 17, wherein said informational display includes a number of schematic figures, icons, or wording to represent each step of said sequence.

20. A dispenser having a housing adapted to accommodate a container; said container having a movable panel and an opening situated opposite said movable panel; said housing having, situated in a portion of said housing opposite an access port, a tension-based member adapted to contact or engage with said movable panel, such that as contents of said container are removed from said container, said tension-based member advances said movable panel toward said container opening and housing access port.

21. The dispenser according to claim 20, wherein said movable panel in said container constitutes a portion of a back-facing or bottom part of a box, and said container opening is a portion of a front-facing or top part of a box.

22. The dispenser according to claim 20, wherein said container opening and said housing access port correspond with each other and have a similar shape and dimensions.

23. The dispenser according to claim 20, wherein said container opening and said housing access port each has a middle section and two terminal sections, in which said middle section has a narrower dimension relative to either of said terminal sections, wherein said terminal section are either of substantially the same shape, size, or dimensions as each other, or one of said terminal sections is larger and has a different shape relative to said other terminal section.

24. The dispenser according to claim 20, wherein said container opening and said housing access port each has either an hourglass-like shape, a paddle-like shape, or a dog-bone-like shape.

25. The dispenser according to claim 20, wherein said container is adapted for holding face masks or gloves.

26. A method for informing a user about a proper sequence or protocol for applying, donning, or using protective products, the method comprises: providing a dispenser device having a housing body with an informational schematic or display that instructs a user on said products; providing to or having said user follow instruction by means of a number of schematic figures, icons, or wording to represent each step of said sequence.

27. The method according to claim 26, further comprising the steps of: first either cleaning or sanitizing said user's hands or other body part using a cleaning or sanitizing medium; second donning a protective covering over a major portion of said user's body; optionally donning either a facial or head cover; and third donning a glove.

28. The method according to claim 26, further comprising the steps of: donning a protective covering and a glove.

29. The method according to claim 26, wherein said protocol is adapted to maintain sanitary or hygienic conditions in a healthcare or laboratory setting.

30. The method according to claim 26, wherein said informational display provides instruction on a method for properly donning anti-infectious products.

31. The method according to claim 30, wherein said protocol complies with U.S. Center for Disease Control-suggested guidelines.
